(19) United States
(12) Patent Application Publication
(10) Pub. No.: US 2008/0312062 A1
(43) Pub. Date: Dec. 18, 2008

(54) OPTICAL GLASS AND LENS

(75) Inventors: Jun SASAI, Tokyo (JP); Naoki Sugimoto, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: ASAHI GLASS COMPANY, LIMITED, TOKYO (JP)

(21) Appl. No.: 12/195,477

(22) Filed: Aug. 21, 2008

Related U.S. Application Data
(63) Continuation of application No. PCT/JP07/53313, filed on Feb. 22, 2007.

(30) Foreign Application Priority Data
Feb. 24, 2006 (JP) 2006-047929

(51) Int. Cl. C03C 3/15

(52) U.S. Cl. 501/50

(57) ABSTRACT

The invention provides an optical glass comprising, by mass % on the oxide basis; 25 to 50% of B₂O₃; 5 to 25% of ZnO: 13 to 25% of La₂O₃; 10 to 28% of Gd₂O₃; and 1.5 to 4% of Li₂O, the optical glass having: a refractive index (n_{d}) of 1.65 to 1.76; an Abbe number (ν_{d}) of 45 to 60; and a molding temperature (Tₚ), as defined with the glass transition temperature (T_{g}) and the yield point (At) by the expression At+(At−T_{g})/2, of 650° C. or less; the optical glass substantially containing neither an arsenic nor a lead nor a fluorine.

### TECHNICAL FIELD

The present invention relates to an optical glass and a lens using the same.

### BACKGROUND ART

As a result of the spread of digital cameras and the like, the recent trends toward higher degrees of integration and function advancement in appliances employing an optical system are rapid and there is a growing desire for weight and size reductions in optical systems. For realizing this desire, optical designs employing an aspherical lens made of a high-performance glass are becoming a main stream. Usually, such glasses are heated to a temperature at which molding is possible and are then molded by precision press-molding to produce aspherical lenses. In particular, although large-aperture lenses which have recently been used are spherical lenses, these lenses are being replaced by aspherical lenses having larger apertures in order to further advance functions. The high-performance glasses for use in producing these lenses are increasingly required to have a high refractive index and low-dispersion characteristics. Various glasses containing B₂O₃ and La₂O₃ as main components are known as glasses heretofore in use which satisfy these requirements and have a high refractive index and low-dispersion characteristics.

However, those glasses heretofore in use have a problem that they generally have a high molding temperature Tₚ.

High molding temperatures Tₚ arouse the following problem. The mold to be used in high-precision press molding is required to enable processing with high surface accuracy and to have properties which do not change at the molding temperature. Because of this, the mold is made of WC, which is a superhard alloy, and the surface thereof is coated with, e.g., a metal such as gold as a release film so as to prevent the mold from adhering to glasses. However, even when the mold surface is coated with the release film, resistance to repetitions of cycling decreases as the forming temperature rises. There has hence been a desire for a press-forming process conducted at a lower temperature.

Various glasses comprising B₂O₃, La₂O₃, and Li₂O as main components are known as optical glasses having a low yield point which have been proposed in order to overcome the problem concerning such a high molding temperature Tₚ. However, these glasses each are one designed mainly for chemical durability, unsusceptibility to thermal devitrification, and low-press-molding-temperature characteristics, and essentially contain rare-earth elements, e.g., La₂O₃, in a large amount. There has hence been a problem that these glasses are apt to be devitrified during a high-temperature forming process such as, e.g., casting or gob forming.

Furthermore, in a precision press-molding process, the phenomenon called sinking occurs in which the shape imparted by the pressing comes to differ from the final shape due to thermal shrinkage, making it difficult to conduct high-precision molding. For preventing this phenomenon, a process is generally used in which the work is cooled to a low temperature while applying an exceedingly high pressure thereto.

In order to overcome that problem, patent document 1 discloses glasses which comprise B₂O₃-La₂O₃—Gd₂O₃—ZnO as main components and have a refractive index n_{d} of 1.72 to 1.83, Abbe number ν_{d} of 45 to 55, glass transition temperature T_{g} of 630° C. or less, and viscosity at the liquidus temperature of 0.6 Pa·s or more. However, since the total content of La₂O₃—Gd₂O₃ in each of these glasses is as high as 14 mol % or above, they each have a molding temperature Tₚ higher than 650° C. It is therefore difficult to consider these glasses to be optical glasses suitable for general molding.

Patent document 2 discloses an optical glass for precision pressing which comprises B₂O₃-Li₂O—Gd₂O₃-LaF₃ as essential components and has a yield point of 570° C. or less so as to have a reduced molding temperature Tₚ. However, this glass has an increased thermal expansion coefficient because it contains fluorine, and this newly poses the following problem. The mold made of a superhard alloy which is for use in press-molding a glass having a high refractive index and low-dispersion characteristics has a lower thermal expansion coefficient than that optical glass. Because of a difference in thermal expansion between the mold and the optical glass, stress is concentrated on the edge part, which is the thinnest in the aspherical lens. As a result, this lens breaks during cooling.

Furthermore, patent documents 3 and 4 disclose glasses having a low press-molding temperature and high-refractive-index/low-dispersion characteristics. These glasses contain B₂O₃ and La₂O₃ as main components, and respectively have a refractive index n_{d} of 1.65 to 1.70, Abbe number ν_{d} of 50 to 56, and yield point At of 630° C. or less and have a refractive index n_{d} of 1.66 to 1.77, Abbe number ν_{d} of 43 to 55, and yield point At of 620° C. or less. However, these prior-art techniques are intended to provide an optical glass excellent only in press-molding suitability, and the patent documents include no statement concerning devitrification characteristics during a high-temperature forming process.

Patent Document 1: JP-A-2002-249337 (Claims)

Patent Document 2: JP-A-3-16932 (Means for Solving the Problems)

Patent Document 3: JP-A-8-59282

Patent Document 4: JP-A-8-26766

### DISCLOSURE OF THE INVENTION

### Problems to be Resolved by the Invention

For overcoming the problems described above, a glass combining a lower molding temperature Tₚ and an average thermal expansion coefficient α which is close to that of the mold material is desirable. Usually, a glass melt undergoes devitrification, i.e., formation of a crystalline precipitate, during solidification. The highest temperature at which devitrification does not occur in a glass held at that temperature is defined as liquidus temperature (T_{L}). In the case of conducting precision preform forming, the temperature at which the glass flows out should be not higher than the heat resistance temperature of the nozzle through which the molten glass flows out. However, in order that the glass melt which has flowed out through the nozzle might undergo no devitrification, the liquidus temperature T_{L} should be not higher than the heat resistance temperature of the nozzle. This temperature generally is 970° C. or less. Furthermore, a glass having a low liquidus temperature T_{L} can have a wide forming temperature region in a viscosity region capable of precision preform forming. A preform having a desired shape can hence be produced from this glass without causing devitrification during the forming. Namely, to have a low liquidus temperature T_{L} means to have excellent devitrification characteristics, and a glass having a sufficiently low liquidus temperature T_{L} so as to suffer no devitrification in high-temperature forming processes is desirable.

On the other hand, there is a desire for a technique for separating a preform of a larger size by any of those forming methods in view of requirements for large-aperture aspherical lenses. It is known that separable preforms increase in size as the specific gravity of the glass decreases, and a specific gravity of 4.30 or less is necessary. An object of the invention, which is for overcoming those problems, is to provide an optical lens which has a low liquidus temperature T_{L} and hence has excellent devitrification characteristics during high-temperature forming and which further has excellent press-molding suitability and enables weight and size reductions in an optical system. Another object is to provide a lens comprising the glass.

### Means of Solving the Problems

The present inventors made intensive investigations in order to eliminate the problems described above. As a result, they have found that those objects can be accomplished with the optical glass shown below and a lens comprising the optical glass. The invention has been thus completed.

(1) An optical glass comprising, by mass % on the oxide basis; 25 to 50% of B₂O₃; 5 to 25% of ZnO: 13 to 25% of La₂O₃; 10 to 28% of Gd₂O₃; and 1.5 to 4% of Li₂O, the optical glass having: a refractive index (n_{d}) of 1.65 to 1.76; an Abbe number (ν_{d}) of 45 to 60; and a molding temperature (Tₚ), as defined with the glass transition temperature (T_{g}) and the yield point (At) by the expression At+(At−T_{g})/2, of 650° C. or less; the optical glass substantially containing neither an arsenic nor a lead nor a fluorine.

(2) The optical glass according to item 1, wherein the total content of La₂O₃ and Gd₂O₃ is 30 to 50% by mass % on the oxide basis.

(3) The optical glass according to item 1 or 2, wherein an average thermal expansion coefficient (a) in the range of 50 to 350° C. is 66×10⁻⁷ K⁻¹ to 84×10⁻⁷ K⁻.

(4) The optical glass according to any one of items 1 to 3, the optical glass has a specific gravity of 4.30 or less.

(5) The optical glass according to any one of items 1 to 4, which has a liquidus temperature (T_{L}) of 970° C. or less.

(6) A lens comprising the optical glass according to any one of items 1 to 5.

### ADVANTAGEOUS EFFECTS OF THE INVENTION

The invention can provide an optical glass which is excellent in devitrification characteristics in high-temperature forming and press-molding suitability and enables weight and size reductions in an optical system. The invention can further provide a lens comprising this optical glass.

### BEST MODE FOR CARRYING OUT THE INVENTION

B₂O₃ among the components of the optical glass of the invention (hereinafter referred to as “glass of the invention”) is an ingredient which constitutes a glass framework and lowers the liquidus temperature T_{L}, and is essential. The content of B₂O₃ may be any value in the range of 25 to 50%. In case where the content thereof is lower than 25% by mass (hereinafter expressed simply as “%”), vitrification is difficult or a heightened liquidus temperature T_{L} results. The content thereof is preferably 30% or more. When a lower liquidus temperature is desired, the content of B₂O₃ is preferably 32% or more, more preferably 34% or more. When an Abbe number ν_{d} increased to 49 to 57 is desired in addition to such a low liquidus temperature, the B₂O₃ content is preferably 35% or more. In case where the B₂O₃ content exceeds 50%, this glass has a reduced refractive index n_{d} or is reduced in chemical durability, e.g., water resistance. Preferably, the content thereof is 45% or less. When the refractive index n_{d} is desired to be increased to 1.69 to 1.75, the B₂O₃ content is preferably 43% or less, more preferably 40% or less.

ZnO is an ingredient which stabilizes the glass, and is essential. The content of ZnO may be any value in the range of 5 to 25%. In case where the content thereof is lower than 5%, this glass is unstable. The content thereof is preferably 10% or more, more preferably 12% or more. In case where the content thereof exceeds 25%, the glass becomes unstable rather than is stabilized, or has reduced chemical durability. The content thereof is preferably 23% or less, more preferably 21% or less.

La₂O₃ is an ingredient which increases the refractive index n_{d} and improves chemical durability, and is essential. The content of La₂O₃ may be any value in the range of 13 to 25%. In case where the content thereof is lower than 13%, this glass has a reduced refractive index n_{d}. The content thereof is preferably 15% or more, more preferably 17% or more. In case where the content thereof exceeds 25%, vitrification becomes difficult to heighten the molding temperature Tₚ or a heightened liquidus temperature T_{L} results. The content thereof is preferably 23% or less, more preferably 21% or less.

Gd₂O₃ is an ingredient which, like La₂O₃, increases the refractive index n_{d} and improves chemical durability, and is essential. The content of Gd₂O₃ may be any value in the range of 10 to 28%. In case where the content thereof is lower than 10%, this glass has a reduced refractive index n_{d}. The content thereof is preferably 15% or more, more preferably 17% or more. In case where the content thereof exceeds 28%, vitrification becomes difficult to heighten the molding temperature Tₚ or a heightened liquidus temperature T_{L} results. The content thereof is preferably 25% or less, more preferably 23% or less.

The total content of La₂O₃ and Gd₂O₃ is desirably from 30% to 50%. In case where the total content thereof is lower than 30%, there is a possibility that this glass might have a reduced refractive index n_{d} or reduced chemical durability. The total content thereof is preferably 34% or more, more preferably 36% or more. In case where the total content thereof exceeds 50%, this glass has a heightened molding temperature Tₚ and is apt to suffer devitrification. The total content thereof is preferably 47% or less, more preferably 45% or less.

Li₂O is an ingredient which stabilizes the glass and lowers the molding temperature Tₚ or melting temperature, and is essential. The content of Li₂O may be any value in the range of 1.5 to 4%. In case where the content thereof is lower than 1.5%, this glass has too high a molding temperature Tₚ or melting temperature. The content thereof is preferably 1.7% or more, more preferably 2% or more. In case where the content thereof exceeds 4%, devitrification is apt to occur and there is a possibility that this glass might have reduced chemical durability or undergo severe volatilization during melting. The content thereof is preferably 3.5% or less, more preferably 3% or less.

The glass of the invention substantially contains neither an arsenic nor a lead nor a fluorine. The reasons for this are as follows. Arsenic and lead are harmful substances, and containing substantially no arsenic and substantially no lead is effective in reducing the burden to be imposed on the environment. The reason why the glass of the invention contains substantially no fluorine is that containing fluorine heightens the thermal expansion coefficient of the glass and this adversely influences formability. Furthermore, containing fluorine not only enhances the burden to be imposed on the environment but also results in mold material damage due to volatilization during preform forming and in enhanced glass inhomogeneity due to volatilization during melting.

The term “containing substantially no . . . ” in the invention means that the content of this ingredient is 0.0001% or less.

ZrO₂, although not essential, may be contained in an amount of 0 to 5% for the purposes of, e.g., stabilizing the glass, increasing the refractive index n_{d}, and inhibiting devitrification during high-temperature forming. In case where the content thereof exceeds 5%, there is a possibility that this glass might have too high a molding temperature Tₚ or too small an Abbe number ν_{d}. The content thereof is preferably 4% or less, more preferably 3% or less.

When it is desired to inhibit devitrification during forming, the content of ZrO₂ in the glass is preferably 0.2% or more, more preferably 0.4% or more.

TiO₂, although not essential, may be contained in an amount of 0 to 5% for the purposes of, e.g., stabilizing the glass, increasing the refractive index n_{d}, and inhibiting devitrification during high-temperature forming. In case where the content thereof exceeds 5%, there is a possibility that this glass might have too small an Abbe number ν_{d} or a reduced transmittance. The content thereof is preferably 3% or less.

WO₃ and Nb₂O₅, although not essential, may be contained in an amount of 0 to 10% for the purposes of, e.g., stabilizing the glass, increasing the refractive index n_{d}, and inhibiting devitrification during high-temperature forming. In case where the content thereof exceeds 10%, there is a possibility that this glass might have too small an Abbe number ν_{d} or a reduced transmittance. The content thereof is preferably 7% or less.

Y₂O₃, although not essential, may be contained in an amount of 0 to 10% for the purposes of, e.g., increasing the refractive index n_{d} and inhibiting devitrification during high-temperature forming. In case where the content thereof exceeds 10%, there are possibilities that the glass might become unstable rather than is stabilized and that the glass might have too high a molding temperature Tₚ, etc. The content thereof is preferably 7% or less.

Ta₂O₅, although not essential, may be contained in an amount of 0 to 16% for the purposes of, e.g., stabilizing the glass, increasing the refractive index n_{d}, and inhibiting devitrification during high-temperature forming. In case where the content thereof exceeds 16%, there is a possibility that this glass might have too high a molding temperature Tₚ or too small an Abbe number ν_{d}. The content thereof is preferably 13% or less, more preferably 10% or less.

SiO₂, although not essential, may be contained in an amount of 0 to 15% for the purposes of, e.g., stabilizing the glass and inhibiting devitrification during high-temperature forming. In case where the content thereof exceeds 15%, there is a possibility that this glass might have too high a molding temperature Tₚ or too low a refractive index n_{d}. The content thereof is preferably 12% or less, more preferably 10% or less.

Al₂O₃, Ga₂O₃, GeO₂, and P₂O₅, although not essential, may be contained in an amount of 0 to 10% for the purposes of, e.g., stabilizing the glass and regulating the refractive index n_{d}. In case where the content thereof exceeds 10%, there is a possibility that this glass might have too small an Abbe number ν_{d}. The content thereof is preferably 8% or less, more preferably 6% or less.

In the case where the glass contains SiO₂, Al₂O₃, Ga₂O₃, and GeO₂, it is desirable that the total content of B₂O₃, SiO₂, Al₂O₃, Ga₂O₃, and GeO₂ is from 30% to 45%. In case where the total content thereof is lower than 30%, vitrification is difficult or a heightened liquidus temperature T_{L} results. The total content thereof is preferably 33% or more, more preferably 35% or more. In case where the total content thereof exceeds 45%, there is a possibility that this glass might have a reduced refractive index n_{d} or a heightened molding temperature Tₚ. The total content thereof is preferably 42% or less, more preferably 40% or less.

BaO, SrO, CaO, and MgO, although not essential, may be contained each in an amount of 0 to 15% for the purposes of, e.g., stabilizing the glass, increasing the Abbe number ν_{d}, lowering the molding temperature Tₚ, and reducing the specific gravity. In case where the content thereof exceeds 15%, there is a possibility that the glass might become unstable rather than is stabilized or the glass might have a reduced refractive index n_{d}, etc.

In the case where the glass contains BaO, SrO, CaO, and MgO, it is desirable that the total content of ZnO, BaO, SrO, CaO, and MgO is from 10% to 30%. In case where the total content thereof is lower than 10%, this glass is unstable or has too high a molding temperature. The total content thereof is preferably 13% or more, more preferably 16% or more. In case where the total content thereof exceeds 30%, there are possibilities that the glass might become unstable rather than is stabilized and that the glass might have a reduced refractive index n_{d}, reduced chemical durability, etc. The total content thereof is preferably 25% or less, more preferably 22% or less.

When the glass is desired to be more highly inhibited from devitrifying during high-temperature forming, the glass preferably comprises 30 to 40% B₂O₃, 10 to 20% ZnO, 17 to 21% La₂O₃, 19 to 24% Gd₂O₃, and 2 to 3% Li₂O, provided that La₂O₃+Gd₂O₃ is 36 to 45%.

Furthermore, when devitrification during high-temperature forming is desired to be more highly inhibited, it is more preferred that the content of ZrO₂ or TiO₂ be regulated to 0.1 to 4%.

The glass of the invention essentially comprises the ingredients described above. However, it may contain other ingredients as long as this does not defeat the objects of the invention. In the case where the glass contains ingredients other than those described above, the total content of these ingredients is preferably 10% or less, more preferably 8% or less, typically not higher than 6% or 5%.

For example, Sb₂O₃ may be contained in an amount of, e.g., 0 to 1% for the purpose of clarification, etc. When the stability of the glass is desired to be enhanced, the refractive index n_{d} or specific gravity of the glass is desired to be regulated, or the melting temperature thereof is desired to be further lowered, then Na₂O, K₂O, Rb₂O, or Cs₂O may be contained in a total amount of 0 to 5%. In case where the total amount thereof exceeds 5%, there is a possibility that this glass might be unstable or have a reduced refractive index n_{d}, reduced hardness, or reduced chemical durability. When the glass is desired to have an increased hardness or improved chemical durability, it is preferred that the glass contains none of those ingredients. When the glass is desired to have a higher refractive index n_{d}, lower glass transition temperature T_{g}, etc., it may contain SnO in an amount of 0 to 4%.

When the glass is desired to have a higher refractive index n_{d}, etc., it may contain TeO₂ or Bi₂O₃ in a total amount of, e.g., 0 to 6%. In case where the total amount thereof exceeds 6%, there is a possibility that this glass might be unstable or have a considerably reduced transmittance. When the glass is desired to have a larger Abbe number ν_{d}, it is preferred that the glass contains neither TeO₂ nor Bi₂O₃.

It is preferred that the glass of the invention contains none of PbO, As₂O₃, and Tl₂O. Although it is preferred that the glass of the invention contains no Fe₂O₃, this ingredient usually comes unavoidably from raw materials. Even in this case, however, the content of Fe₂O₃ is preferably 0.0001% or less and not more than 0.0001% by mass.

More preferably, the optical glass of the invention is an optical glass which comprises, in terms of % by mass on the oxide basis, 30 to 45% B₂O₃, 10 to 23% ZnO, 15 to 23% La₂O₃, 15 to 25% Gd₂O₃, and 1.7 to 3.5% Li₂O and has a refractive index (n_{d}) of 1.65 to 1.76, an Abbe number (ν_{d}) of 45 to 60, and a value of molding temperature (Tₚ), as defined with the glass transition temperature (T_{g}) and the yield point (At) by the expression At+(At−T_{g})/2, of 650° C. or less, the optical glass substantially containing neither an arsenic nor a lead nor a fluorine.

In case where the refractive index n_{d} of the glass of the invention is 1.65 or less, it is difficult to obtain sufficient properties necessary for lens size reduction. The refractive index n_{d} thereof is preferably 1.67 or more, more preferably 1.68 or more. On the other hand, in case where the refractive index n_{d} of the glass of the invention exceeds 1.76, this glass has too small an Abbe number ν_{d}. The refractive index n_{d} thereof is preferably 1.75 or less, more preferably 1.74 or less, even more preferably 1.73 or less. The Abbe number ν_{d} of the glass of the invention is typically from 45 to 60. When the refractive index n_{d} is 1.68 to 1.74, the Abbe number ν_{d} is typically from 47 to 58.

The molding temperature Tₚ of the glass of the invention is preferably 650° C. or less. In the invention, molding temperature Tₚ is a temperature defined with the glass transition temperature T_{g} and the yield point At by the expression At+(At−T_{g})/2. In case where the molding temperature Tₚ exceeds 650° C., there is a possibility that this glass might arouse problems concerning press-molding suitability, for example, that volatilization during preform molding damages the mold material and reduces the resistance of the mold to repetitions of cycling. The molding temperature Tₚ of the glass is more preferably 645° C. or less, especially preferably 640° C. or less.

The coefficients of thermal expansion a of the molds made of a superhard alloy to be used for press-molding the glass are about 40×10⁻⁷ to 50×10⁻⁷ K⁻¹. Because of this, the thermal expansion coefficient α of the glass of the invention desirably is close to that value. Namely, the thermal expansion coefficient α of the glass of the invention preferably is 82×10⁻⁷ K⁻¹ or less. In case where the thermal expansion coefficient α thereof is 84×10⁻⁷ K⁻¹ or more, this glass highly tends to break during press-molding or sinking occurs to make precision molding difficult. The thermal expansion coefficient α thereof is more preferably from 68×10⁻⁷ K⁻¹ to 80×10⁻⁷ K⁻¹, even more preferably from 69×10⁻⁷ K⁻¹ to 78×10⁻⁷ K⁻¹. The specific gravity of the glass of the invention is 4.30 or less. In case where the specific gravity thereof exceeds 4.30, it is difficult to obtain a desired preform mass. The specific gravity of the glass of the invention is preferably 4.25 or less, more preferably 4.20 or less, especially preferably 4.10 or less.

The liquidus temperature T_{L} of the glass of the invention is 970° C. or less. In case where the liquidus temperature T_{L} thereof is higher than 970° C., it is difficult to inhibit devitrification during high-temperature forming such as casting or gob molding. The liquidus temperature T_{L} of the glass of the invention is preferably 960° C. or less, more preferably 950° C. or less, especially preferably 940° C. or less. Because the glass of the invention has a low liquidus temperature T_{L} as described above, it has excellent devitrification characteristics.

The glass of the invention is suitable for use as lenses for digital cameras and the like such as those described hereinabove. Namely, such lenses are lenses of the invention. Typically, these are produced by processing the glass of the invention to obtain a preform, heating this preform to soften it, and press-molding the preform with a mold (precision press-molding). Incidentally, the preform may be produced by forming the glass in a molten state.

### EXAMPLES

The present invention is now illustrated in greater detail with reference to Examples (Examples 1 to 33) and Comparative Examples (Examples 34 to 36), but it should be understood that the present invention is not to be construed as being limited thereto.

Raw materials were mixed together so as to obtain a glass having each of the compositions shown in terms of % by mass in the respective columns ranging from B₂O₃ to TiO₂ or Sb₂O₃ in Tables 1 to 6. Each mixture was placed in a platinum crucible and melted by heating at 1,100 to 1,300° C. for 1 hour. During this operation, the melt was stirred with a stirrer made of platinum for 0.5 hours to homogenize the molten glass. The molten glass homogenized was poured and formed into a plate shape. Thereafter, the platy glass was held at a temperature of glass transition temperature T_{g}+10° C. for 4 hours and then gradually cooled to room temperature at a cooling rate of −1° C./min.

As the raw materials were used: boron oxide, lithium carbonate, zirconium dioxide, zinc oxide, calcium carbonate, strontium carbonate, titanium oxide, and antimony oxide each of the special grade manufactured by Kanto Chemical Co., Ltd.; lanthanum oxide and gadolinium oxide each having a purity of 99.9% manufactured by Shin-Etsu Chemical Co., Ltd.; and tantalum oxide, silicon dioxide, and aluminum oxide each having a purity of 99.9% or more manufactured by Kojundo Chemical Laboratory Co., Ltd.

The glasses obtained were examined for glass transition temperature T_{g}, yield point At (unit: ° C.), average linear expansion coefficient α in the range of 50 to 300° C. (unit: ×10⁻⁷ K⁻¹), refractive index n_{d} at a wavelength of 587.6 nm (d-line), Abbe number ν_{d}, liquidus temperature T_{L} (unit: ° C.), and specific gravity d. The methods used for determining T_{g}, At, α, n_{d}, ν_{d}, T_{L}, and d are as follows.

T_{g}, At, α: A sample processed into a cylindrical shape having a diameter of 5 mm and a length of 20 mm was examined with thermomechanical analyzer DILATOMETER 5000 (trade name), manufactured by MAC Science Co., Ltd., at a heating rate of 5° C./min.

n_{d}, ν_{d}: A sample processed into a rectangular shape having a length of each side of 20 mm and a thickness of 10 mm was examined with a refractive index measurement apparatus (product of Kalnew Optical Industrial Company; trade name: KPR-2). Measurements were made to five decimal places. Five places of decimals of each of the measurement values were detected. The third place after the decimal point of the refractive index n_{d} was rounded off, and the second place after the decimal point of the Abbe number ν_{d} was rounded off.

T_{L}: A sample processed into a cubic shape having a length of each side of 10 mm was placed on a platinum plate. This sample on the plate was allowed to stand for 1 hour in an electric furnace set at a given temperature, and was then taken out and examined with an optical microscope having a magnification of 10 diameters. The highest temperature which did not result in crystal precipitation is taken as T_{L}.

d: A sample processed into a rectangular shape having a length of each side of 20 mm and a thickness of 10 mm was examined with a specific gravimeter (trade name, SGM300P; manufactured by Shimadzu Corp.).

Devitrification characteristics were evaluated by holding a sample at 970° C. for 1 hour and then examined for devitrification. The samples which suffered no devitrification and were satisfactory are indicated by ∘, while those which suffered devitrification are indicated by x.

TABLE 1
Example

| | 1 | 2 | 3 | 4 | 5 | 6 | 7 |
|---|---|---|---|---|---|---|---|
| B₂O₃ | 33.9 | 34.1 | 33.1 | 32.5 | 39.1 | 38.8 | 38.6 |
| Li₂O | 2.30 | 2.33 | 2.25 | 3.05 | 2.09 | 2.10 | 2.05 |
| ZrO₂ | 0.00 | 2.57 | 0.00 | 0.00 | 0.00 | 0.00 | 0.00 |
| ZnO | 19.9 | 20.2 | 19.6 | 16.5 | 16.7 | 15.2 | 12.0 |
| La₂O₃ | 20.7 | 19.3 | 17.1 | 21.2 | 19.0 | 19.0 | 18.8 |
| Gd₂O₃ | 23.2 | 21.5 | 19.1 | 23.6 | 21.2 | 21.1 | 20.9 |
| CaO | 0.00 | 0.00 | 0.00 | 0.00 | 0.00 | 0.00 | 0.00 |
| SrO | 0.00 | 0.00 | 0.00 | 0.00 | 1.91 | 3.80 | 7.65 |
| Ta₂O₅ | 0.00 | 0.00 | 8.85 | 0.00 | 0.00 | 0.00 | 0.00 |
| SiO₂ | 0.00 | 0.00 | 0.00 | 3.15 | 0.00 | 0.00 | 0.00 |
| TiO₂ | 0.00 | 0.00 | 0.00 | 0.00 | 0.00 | 0.00 | 0.00 |
| La₂O₃ + Gd₂O₃ | 43.9 | 40.8 | 36.2 | 44.8 | 40.2 | 40.1 | 39.7 |
| n_{d} | 1.72 | 1.72 | 1.73 | 1.71 | 1.70 | 1.70 | 1.70 |
| ν_{d} | 52.2 | 51.7 | 49.5 | 52.8 | 54.5 | 54.7 | 55.1 |
| T_{L} | 950 | 920 | 960 | 960 | 910 | 910 | 950 |
| T_{g} | 533 | 541 | 545 | 534 | 556 | 552 | 559 |
| At | 588 | 589 | 594 | 583 | 610 | 606 | 610 |
| Tₚ | 615 | 613 | 619 | 607 | 637 | 633 | 636 |
| α | 73.5 | 74.8 | 71.8 | 78.6 | 71.0 | 75.8 | 81.5 |
| d | 4.18 | 4.14 | 4.22 | 4.09 | 3.95 | 3.95 | 3.97 |
| Devitrification | ∘ | ∘ | ∘ | ∘ | ∘ | ∘ | ∘ |
| characteristics | | | | | | | |

TABLE 2
Example

| | 8 | 9 | 10 | 11 | 12 | 13 | 14 |
|---|---|---|---|---|---|---|---|
| B₂O₃ | 39.5 | 37.1 | 37.5 | 36.8 | 35.3 | 34.0 | 33.9 |
| Li₂O | 2.69 | 2.10 | 2.19 | 2.15 | 2.27 | 2.26 | 2.26 |
| ZrO₂ | 0.00 | 0.00 | 2.41 | 0.00 | 2.53 | 2.53 | 2.52 |
| ZnO | 9.24 | 19.0 | 19.1 | 18.8 | 19.8 | 20.1 | 20.0 |
| La₂O₃ | 19.3 | 19.8 | 18.4 | 18.0 | 19.0 | 19.3 | 19.2 |
| Gd₂O₃ | 21.4 | 22.0 | 20.4 | 20.0 | 21.1 | 21.4 | 21.3 |
| CaO | 0.00 | 0.00 | 0.00 | 0.00 | 0.00 | 0.00 | 0.00 |
| SrO | 7.87 | 0.00 | 0.00 | 0.00 | 0.00 | 0.00 | 0.00 |
| Ta₂O₅ | 0.00 | 0.00 | 0.00 | 4.25 | 0.00 | 0.00 | 0.00 |
| SiO₂ | 0.00 | 0.00 | 0.00 | 0.00 | 0.00 | 0.00 | 0.00 |
| TiO₂ | 0.00 | 0.00 | 0.00 | 0.00 | 0.00 | 0.41 | 0.82 |
| La₂O₃ + Gd₂O₃ | 40.7 | 41.8 | 38.8 | 38.0 | 40.1 | 40.7 | 40.5 |
| n_{d} | 1.69 | 1.71 | 1.71 | 1.71 | 1.72 | 1.73 | 1.72 |
| ν_{d} | 55.4 | 53.4 | 52.8 | 52.1 | 52.0 | 51.1 | 49.9 |
| T_{L} | 950 | 910 | 890 | 910 | 900 | 910 | 900 |
| T_{g} | 551 | 550 | 553 | 551 | 538 | 534 | 534 |
| At | 601 | 602 | 604 | 603 | 592 | 585 | 588 |
| Tₚ | 626 | 628 | 629 | 629 | 619 | 610 | 615 |
| α | 79.8 | 72.4 | 69.8 | 70.5 | 72.7 | 75.6 | 73.8 |
| d | 3.91 | 4.03 | 3.99 | 4.04 | 4.08 | 4.13 | 4.13 |
| Devitrification | ∘ | ∘ | ∘ | ∘ | ∘ | ∘ | ∘ |
| characteristics | | | | | | | |

TABLE 3
Example

| | 15 | 16 | 17 | 18 | 19 | 20 | 21 |
|---|---|---|---|---|---|---|---|
| B₂O₃ | 33.9 | 35.2 | 35.4 | 38.7 | 39.1 | 38.7 | 38.2 |
| Li₂O | 2.30 | 2.26 | 2.20 | 2.04 | 2.10 | 2.07 | 2.04 |
| ZrO₂ | 1.30 | 1.24 | 2.48 | 0.00 | 1.13 | 1.14 | 1.13 |
| ZnO | 20.1 | 19.7 | 19.7 | 13.6 | 15.2 | 12.1 | 12.7 |
| La₂O₃ | 20.1 | 19.7 | 18.9 | 18.9 | 18.3 | 18.1 | 18.6 |
| Gd₂O₃ | 22.3 | 21.9 | 21.0 | 21.0 | 20.3 | 20.2 | 20.7 |
| CaO | 0.00 | 0.00 | 0.00 | 0.00 | 0.00 | 0.00 | 0.00 |
| SrO | 0.00 | 0.00 | 0.00 | 5.76 | 3.87 | 7.69 | 6.63 |
| Ta₂O₅ | 0.00 | 0.00 | 0.00 | 0.00 | 0.00 | 0.00 | 0.00 |
| SiO₂ | 0.00 | 0.00 | 0.00 | 0.00 | 0.00 | 0.00 | 0.00 |
| TiO₂ | 0.00 | 0.00 | 0.32 | 0.00 | 0.00 | 0.00 | 0.00 |
| La₂O₃ + Gd₂O₃ | 42.4 | 41.6 | 39.9 | 39.9 | 38.6 | 38.3 | 39.3 |
| n_{d} | 1.72 | 1.72 | 1.72 | 1.70 | 1.70 | 1.70 | 1.70 |
| ν_{d} | 52.0 | 52.8 | 51.4 | 55.0 | 54.2 | 54.7 | 54.5 |
| T_{L} | 940 | 920 | 890 | 930 | 890 | 940 | 930 |
| T_{g} | 531 | 538 | 543 | 554 | 555 | 557 | 555 |
| At | 584 | 590 | 595 | 607 | 607 | 609 | 608 |
| Tₚ | 611 | 616 | 621 | 634 | 633 | 635 | 634 |
| α | 75.6 | 74.5 | 75.0 | 75.9 | 77.1 | 78.3 | 76.8 |
| d | 4.15 | 4.10 | 4.07 | 3.96 | 3.93 | 3.94 | 3.98 |
| Devitrification | ∘ | ∘ | ∘ | ∘ | ∘ | ∘ | ∘ |
| characteristics | | | | | | | |

TABLE 4
Example

| | 22 | 23 | 24 | 25 | 26 | 27 | 28 |
|---|---|---|---|---|---|---|---|
| B₂O₃ | 38.6 | 39.0 | 38.9 | 38.5 | 38.7 | 38.8 | 39.1 |
| Li₂O | 2.35 | 2.09 | 2.06 | 2.34 | 2.31 | 2.33 | 2.34 |
| ZrO₂ | 1.14 | 1.18 | 1.15 | 0.60 | 0.57 | 0.57 | 0.58 |
| ZnO | 11.3 | 14.4 | 13.6 | 13.1 | 13.2 | 13.3 | 13.3 |
| La₂O₃ | 18.9 | 18.2 | 18.2 | 18.8 | 18.9 | 19.0 | 19.0 |
| Gd₂O₃ | 21.0 | 20.3 | 20.3 | 20.9 | 21.0 | 21.1 | 21.2 |
| CaO | 0.00 | 0.00 | 0.00 | 0.00 | 0.52 | 1.04 | 1.57 |
| SrO | 6.71 | 4.83 | 5.79 | 5.76 | 4.80 | 3.86 | 2.91 |
| Ta₂O₅ | 0.00 | 0.00 | 0.00 | 0.00 | 0.00 | 0.00 | 0.00 |
| SiO₂ | 0.00 | 0.00 | 0.00 | 0.00 | 0.00 | 0.00 | 0.00 |
| TiO₂ | 0.00 | 0.00 | 0.00 | 0.00 | 0.00 | 0.00 | 0.00 |
| La₂O₃ + Gd₂O₃ | 39.9 | 38.5 | 38.5 | 39.7 | 39.9 | 40.1 | 40.2 |
| n_{d} | 1.70 | 1.70 | 1.70 | 1.70 | 1.70 | 1.70 | 1.70 |
| ν_{d} | 54.7 | 54.4 | 54.7 | 55.0 | 54.5 | 55.9 | 54.8 |
| T_{L} | 940 | 910 | 910 | 920 | 920 | 920 | 920 |
| T_{g} | 554 | 562 | 554 | 551 | 552 | 553 | 553 |
| At | 604 | 608 | 608 | 601 | 599 | 600 | 600 |
| Tₚ | 629 | 631 | 635 | 626 | 622 | 624 | 624 |
| α | 78.2 | 73.5 | 74.5 | 78.2 | 79.3 | 76.0 | 76.0 |
| d | 3.97 | 3.94 | 3.94 | 3.97 | 3.94 | 3.93 | 3.92 |
| Devitrification | ∘ | ∘ | ∘ | ∘ | ∘ | ∘ | ∘ |
| characteristics | | | | | | | |

TABLE 5
Example

| | 29 | 30 | 31 | 32 | 33 |
|---|---|---|---|---|---|
| B₂O₃ | 39.2 | 39.1 | 39.1 | 39.5 | 39.7 |
| Li₂O | 2.36 | 2.38 | 2.34 | 2.41 | 2.42 |
| ZrO₂ | 0.58 | 0.58 | 0.58 | 0.60 | 0.61 |
| ZnO | 13.4 | 12.6 | 11.8 | 13.5 | 12.0 |
| La₂O₃ | 19.1 | 19.1 | 19.0 | 19.3 | 19.4 |
| Gd₂O₃ | 21.3 | 21.2 | 21.2 | 21.5 | 21.6 |
| CaO | 2.11 | 2.13 | 2.10 | 3.19 | 4.27 |
| SrO | 1.95 | 2.91 | 3.88 | 0.00 | 0.00 |
| Ta₂O₅ | 0.00 | 0.00 | 0.00 | 0.00 | 0.00 |
| SiO₂ | 0.00 | 0.00 | 0.00 | 0.00 | 0.00 |
| TiO₂ | 0.00 | 0.00 | 0.00 | 0.00 | 0.00 |
| La₂O₃+ Gd₂O₃ | 40.4 | 40.3 | 40.2 | 40.8 | 41.0 |
| n_{d} | 1.70 | 1.70 | 1.70 | 1.70 | 1.70 |
| ν_{d} | 54.8 | 55.0 | 55.0 | 54.7 | 55.1 |
| T_{L} | 920 | 930 | 940 | 920 | 920 |
| T_{g} | 557 | 555 | 555 | 558 | 561 |
| At | 604 | 601 | 604 | 607 | 609 |
| Tₚ | 627 | 624 | 628 | 631 | 632 |
| α | 74.2 | 76.8 | 77.2 | 76.3 | 77.2 |
| d | 3.90 | 3.90 | 3.90 | 3.87 | 3.85 |
| Devitrification | ∘ | ∘ | ∘ | ∘ | ∘ |
| characteristics | | | | | |

TABLE 6
Example

| | 34 | 35 | 36 |
|---|---|---|---|
| B₂O₃ | 32.1 | 40.5 | 42.7 |
| Li₂O | 0.00 | 2.20 | 2.50 |
| ZrO₂ | 5.15 | 0.00 | 0.00 |
| ZnO | 11.9 | 11.3 | 9.70 |
| La₂O₃ | 30.1 | 42.1 | 34.0 |
| Gd₂O₃ | 15.2 | 0.00 | 11.0 |
| CaO | 0.00 | 0.00 | 0.00 |
| SrO | 0.00 | 0.00 | 0.00 |
| Ta₂O₅ | 0.00 | 0.00 | 0.00 |
| SiO₂ | 0.00 | 3.70 | 0.00 |
| TiO₂ | 0.00 | 0.00 | 0.00 |
| Al₂O₃ | 5.55 | 0.00 | 0.00 |
| Sb₂O₃ | 0.00 | 0.20 | 0.10 |
| La₂O₃ + Gd₂O₃ | 45.3 | 42.1 | 45.0 |
| n_{d} | 1.73 | 1.70 | 1.70 |
| ν_{d} | 51.4 | 55.3 | 56.1 |
| T_{L} | 1070 | 980 | 1000 |
| T_{g} | 637 | 564 | 556 |
| At | 682 | 610 | 603 |
| Tₚ | 705 | 634 | 627 |
| α | 77.0 | 69.9 | 71.2 |
| d | 4.16 | 3.72 | 3.80 |
| Devitrification | x | x | x |
| characteristics | | | |

While the present invention has been described in detail and with reference to specific embodiments thereof, it will be apparent to one skilled in the art that various changes and modifications can be made therein without departing from the spirit and scope thereof.

This application is based on a Japanese Patent Application No. 2006-047929 filed on Feb. 24, 2006, and the contents thereof are incorporated herein by reference.

### INDUSTRIAL APPLICABILITY

The optical glass of the invention can be utilized as optical lenses for digital cameras, etc.

1. An optical glass comprising, by mass % on the oxide basis;
25 to 50% of B₂O₃;
5 to 25% of ZnO:
13 to 25% of La₂O₃;
10 to 28% of Gd₂O₃; and
1.5 to 4% of Li₂O,
the optical glass having:
a refractive index (n_{d}) of 1.65 to 1.76;
an Abbe number (ν_{d}) of 45 to 60; and
a molding temperature (Tₚ), as defined with the glass transition temperature (T_{g}) and the yield point (At) by the expression At+(At−T_{g})/2, of 650° C. or less;
the optical glass substantially containing neither an arsenic nor a lead nor a fluorine.

2. The optical glass according to claim 1,
wherein the total content of La₂O₃ and Gd₂O₃ is 30 to 50% by mass % on the oxide basis.

3. The optical glass according to claim 1,
wherein an average thermal expansion coefficient (a) in the range of 50 to 350° C. is 66×10⁻⁷ K⁻¹ to 84×10⁻⁷ K⁻¹.

4. The optical glass according to claim 1,
the optical glass has a specific gravity of 4.30 or less.

5. The optical glass according to claim 1,
which has a liquidus temperature (T_{L}) of 970° C. or less.

6. A lens comprising the optical glass according to claim 1.
